(19) United States
(12) Patent Application Publication
(10) Pub. No.: US 2003/0041506 A1
(43) Pub. Date: Mar. 6, 2003

(54) Insect control apparatus

(76) Inventor: Andrew Paul Coventry, Parkwood (AU)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/219,801

(22) Filed: Aug. 14, 2002

Related U.S. Application Data
(63) Continuation-in-part of application No. 09/802,337, filed on Mar. 9, 2001, now abandoned.
Application No. 09/802,337 is a continuation-in-part of application No. 09/364,357, filed on Jul. 30, 1999, now Pat. No. 6,199,316.

(30) Foreign Application Priority Data
Nov. 26, 1998 (AU) PP 7358

(51) Int. Cl. A01M 1/20

(52) U.S. Cl. 43/132.1

(57) ABSTRACT

An insect control apparatus includes a housing bounding an insect collection chamber. The housing has one or more apertures to allow an insect to enter the chamber. A sonic signal generating system generates and broadcasts a sonic signal which sweeps through a range of frequencies to lure an insect into the insect collection chamber. The sonic generating system is configured to pulse the sonic signal so that the sonic signal is cyclically turned ON and OFF.

### CROSS-REFERENCE TO RELATED APPLICATIONS

This application is a continuation-in-part of U.S. patent application Ser. No. 09/802,337, filed on Mar. 9, 2001 which is a continuation-in-part of U.S. patent application Ser. No. 09/364,357, filed on Jul. 30, 1999, U.S. Pat. No. 6,199,316, which claims priority to Australian Provisional Application No. PP 7358, filed on Nov. 26, 1998, which applications are incorporated herein by specific reference.

### BACKGROUND OF THE INVENTION

1. The Field of the Invention

This invention relates to an insect control apparatus and in particular, but not exclusively, to an insect control apparatus for trapping and/or killing flying insects.

2. The Relevant Technology

Insects, and in particular mosquito trapping and killing devices and methods have been disclosed, as for example as shown in prior U.S. Pat. Nos. 5,813,166 (Wigton et al), U.S. Pat. No. 4,907,366 (Balfour); U.S. Pat. No. 4,506,473 (Waters); and, U.S. Pat. No. 4,332,100 (Schneider). Wigton and Waters, in general terms, utilize carbon dioxide to attract flying insects, Schneider proposes the use of ultraviolet light as an attractant while Balfour utilizes a solution of lactic acid in water and a heater to simulate the body of a human being.

The present invention provides an insect control apparatus utilizing an alternate mechanism for attracting insects.

### SUMMARY OF THE INVENTION

According to the present invention there is provided an insect control apparatus including at least:

a housing defining an insect collection chamber, the housing having one or more apertures to allow an insect to enter the chamber;

a sonic signal generating system for generating and broadcasting a sonic signal sweeping through a frequency range of about 80 Hz to 680 Hz to lure an insect into said insect collection chamber; and,

means disposed in said insect collection chamber for killing or trapping an insect residing in said insect collection chamber.

Preferably the sonic signal generating means further includes pulsing means for pulsing said sonic signal with an adjustable duty cycle. That is, the sonic signal can be cyclically generated for a period as it sweeps through the frequency range, then turned off for a second period before restarting. This is akin to pulsing the sonic signal.

In one embodiment the sonic generator produces the sonic signal for about ten seconds sweeping from about 80 Hz to 680 Hz, turns OFF for about five seconds then restarts and cycles ad infinitum.

Preferably said insect control apparatus further includes apparatus for providing a continuous slow release of a compressed gas within said insect collection chamber. The compressed gas can act either as an additional attractant to the insect to a, and/or as an agent to kill the insect. In the latter instance, the gas acts as said means for killing said insect.

Preferably said apparatus for providing a continuous slow release of compressed gas includes at least:

a pressure vessel having a gas inlet adapted for connection to a supply of compressed gas;

a restrictor tube having a first length provided with a first open end each located within said pressure vessel and a second length provided with a second open end each located outside the pressure vessel, the restrictor tube being configured such that when the supply of compressed gas is connected to the pressure vessel by the gas inlet so that a volume of gas is transferred from the supply of compressed gas to the pressure vessel, the volume of gas enters the first open end of the restrictor tube, travels through the first and second lengths of the restrictor tube and exits from the second open end of the restrictor tube to provide a continuous slow release of the volume of gas from the pressure vessel.

Preferably said apparatus for providing a continuous slow release of compressed gas further includes means for opening, from time to time, a fluid communication path between said supply of compressed gas and said pressure vessel to charge said pressure vessel with said volume of compressed gas.

Preferably said restrictor tube has an internal diameter in the order of 0.5 to 2 mm. Preferably the supply of compressed gas provides gas to said pressure chamber at a pressure of up to 1000 psi.

Preferably said insect control apparatus further includes a light source for producing a light of a wavelength attractive to a range of insects desired to be trapped.

Preferably said light source includes at least two light emitting devices emitting light of different wavelengths.

Preferably said light source includes a light mixer for mixing the light emitted by said light emitting devices.

Preferably said light mixer includes a transparent or translucent prism to which said light emitting devices are optically coupled.

Preferably said prism is provided with an outer surface having an array of surface grooves or scratches for refracting light emitted by said light emitting devices as it passes from the prism to the surrounding atmosphere.

Alternately, or in addition, the outer surface of the prism is frosted.

Preferably said insect control apparatus further includes a light source circuit for pulsing said light emitting devices.

Preferably said insect control apparatus includes a body of liquid held in said insect collection chamber into which insects within said insect collection chamber can fall and become trapped. Advantageously, said liquid includes lactic acid, or octenol or a combination thereof.

Preferably said insect control apparatus further includes air circulation means for circulating air through said housing in a direction to produce a downdraft near said opening toward said body of liquid.

According to the invention there is also provided an insect control apparatus comprising at least:

a housing defining an insect collection chamber, the housing having one or more apertures to allow an insect to enter the chamber;

a sonic signal generating system for generating and broadcasting a sonic signal which sweeps through a range of frequencies to lure an insect into said insect collection chamber said sonic generating system including pulsing means for pulsing said sonic signal so that said sonic signal is cyclically turned ON and OFF; and

means disposed in said insect collection chamber for killing or trapping an insect residing in said insect collection chamber.

According to the invention there is also provided an insect control apparatus comprising at least:

a housing defining an insect collection chamber, the housing having one or more apertures to allow an insect to enter the chamber;

a sonic signal generating system for generating and broadcasting a sonic signal which sweeps through a range of frequencies of about 80 Hz to 680 Hz to lure an insect into said insect collection chamber;

means disposed in said insect collection chamber for killing or trapping an insect residing in said insect collection chamber;

a pressure vessel having a gas inlet adapted for connection to a supply of compressed gas;

a restrictor tube having a first length provided with a first open end each located within said pressure vessel and a second length provided with a second open end each located outside the pressure vessel, the restrictor tube being configured such that when the supply of compressed gas is connected to the pressure vessel by the gas inlet so that a volume of gas is transferred from the supply of compressed gas to the pressure vessel, the volume of as enters the first open end of the restrictor tube, travels through the first and second lengths of the restrictor tube and exits from the second open end of the restrictor tube to provide a continuous slow release of the volume of gas from the pressure vessel into said insect collection chamber; and

means for opening, from time to time, a fluid communication path between said supply of compressed gas and said pressure vessel to charge said pressure vessel with said volume of compressed gas.

### BRIEF DESCRIPTION OF THE DRAWINGS

Embodiments of the present invention will now be described with reference to the accompanying drawings in which:

FIG. 1 is a partial section of an apparatus for the continuous slow release of a compressed gas, which can be incorporated into the insect control apparatus;

FIG. 2 is a side view of the apparatus shown in FIG. 1 attached to a supply of gas;

FIG. 3 is a schematic representation from the side of an insect control apparatus incorporating the apparatus shown in FIGS. 1 and 2;

FIG. 4 is a plan view of the insect control apparatus depicted in FIG. 3;

FIG. 5 is a front view of the insect control apparatus depicted in FIGS. 3 and 4;

FIG. 6a is a perspective view of a light source incorporated in the insect control apparatus;

FIG. 6b is a side view of the light source depicted in FIG. 6a;

FIGS. 7a and 7b illustrate a circuit diagram for controlling various components of the insect control apparatus;

FIG. 8 depicts the electrical connection of components of the insect control apparatus;

FIG. 9 is an embodiment of an alternate form of the apparatus for the continuous slow release of the compressed gas;

FIG. 10 depicts a coupling for coupling the insect control apparatus to a bottle of compressed gas;

FIG. 11 is a circuit diagram of a sonic signal generating means incorporated in the insect control apparatus.

### DETAILED DESCRIPTION OF THE PREFERRED EMBODIMENTS

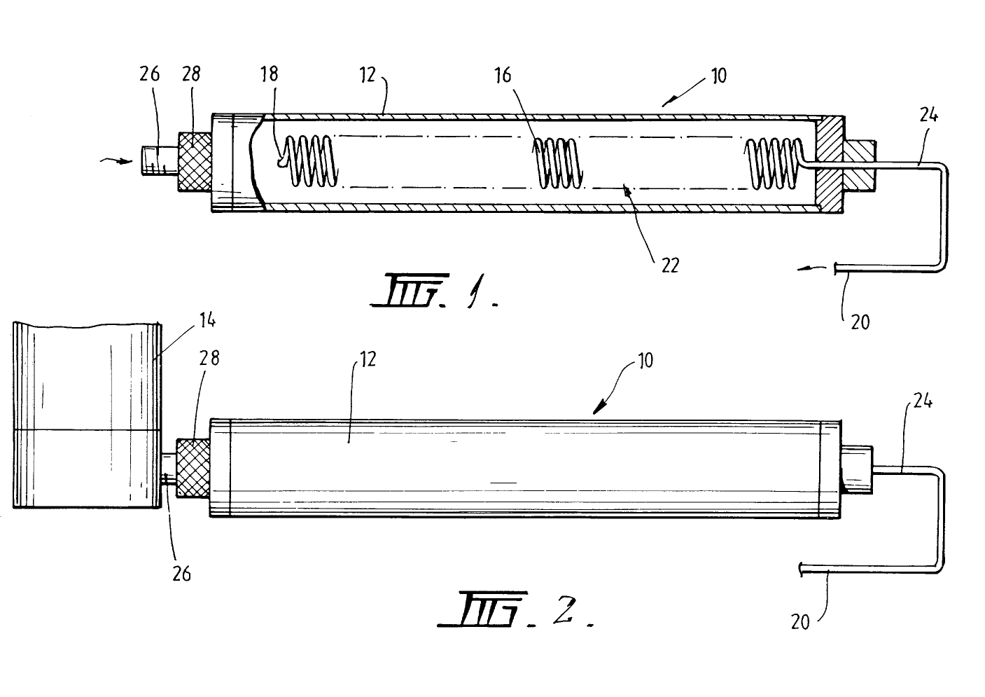

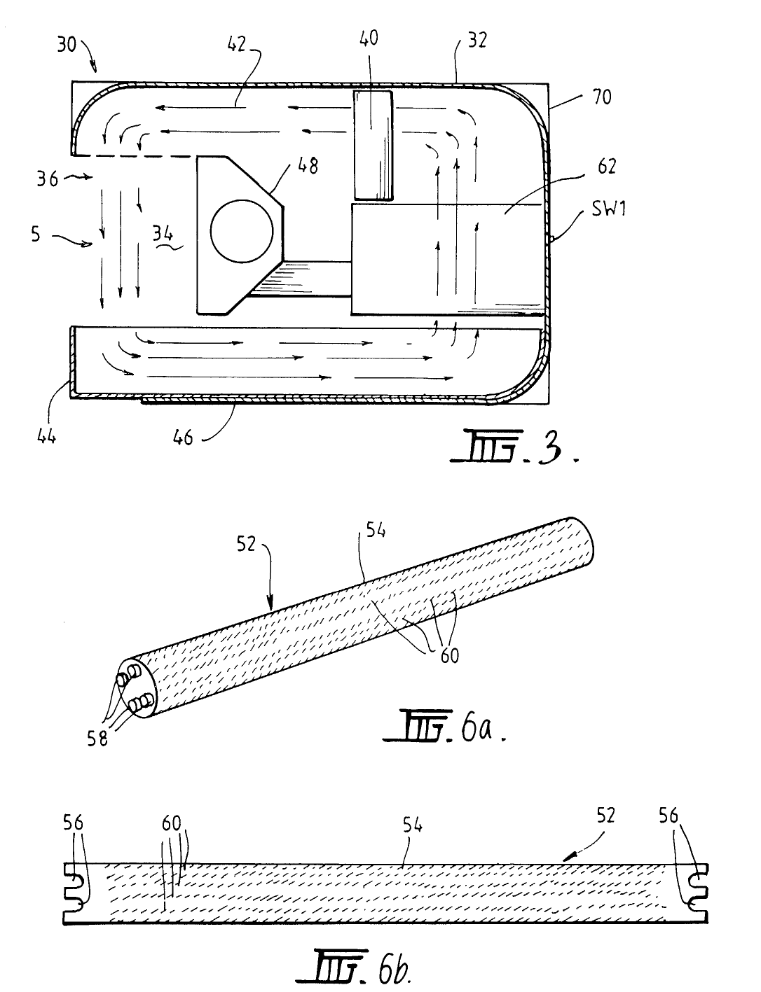

FIGS. 1 and 2 show an apparatus 10 for providing a continuous slow release of a compressed gas includes a pressure vessel 12, adapted for connection to a supply of compressed gas such as a cylinder 14 of compressed gas, and a restrictor tube 16. As explained hereinafter the apparatus 10, can optionally be incorporated into an insect control apparatus according to the present invention. The restrictor tube 16 has a first open end 18 located inside the pressure vessel 12 and an opposite second open end 20 located outside the pressure vessel 12. The restrictor tube 16 is made of a small diameter so as to restrict the flow of gas therethrough and out of the pressure vessel 12. Thus, in use, when a volume of gas is transferred from the cylinder 14 into the pressure vessel 12, the gas enters the first opening 18, travels through the restrictor tube 16 and out the second opening 20 to provide a slow continuous release of the gas.

The tube 16 has a first length 22 located inside the pressure vessel 12 and a second length 24 extending outside the pressure vessel 12. Typically, the first length 22 is coiled for the purpose of saving space, i.e., minimizing the length dimension of the pressure vessel 12, and also for ease of manufacture. The length and diameter of tube 16 and in particular the coiled length 22 affects the time it takes to discharge the gas within the pressure vessel 12. Clearly, the smaller the diameter and longer the length of the tube 16, with all other matters being equal, the longer it will take for the gas to bleed out of the pressure vessel 12. Thus, for different applications, the tube 16 can be replaced with tubes of a different lengths and diameters. Typically the tube 16 or lengths thereof, have an inner diameter of between 0.5 mm to 2 mm.

A gas inlet 26 is provided at one end of the pressure vessel 12 for connection cylinder 14. In order to control the flow of gas from the cylinder 14 into the pressure vessel 12, means in the form of a valve 28 is provided in a fluid communication path between the cylinder 14 and the pressure vessel 12. The valve 28 can be electronically or mechanically operated. The purpose of the valve 28 is to provide a pulse of gas from the cylinder 14 to enter the vessel 12. The valve can be operated on an automatic timer so as to open for a predetermined period, say for example one tenth of a second (100 ms) approximately every thirty seconds and uses approximately 1 gram of gas at each pulse or burst. Thus about 120 grams of gas would be used every hour, that gas being continuously and slowly bled from the pressure vessel 12 via the restrictor tube 16. It is envisaged that the opening duration of the fluid communication path between the cylinder 14 and the pressure vessel 12 can be adjusted and similarly the frequency or cycle time, i.e., time between pulses, can also be adjusted.

Typically the gas pressure within the cylinder 14 is up to 1000 psi. This constitutes the maximum pressure within the pressure vessel 12.

As an alternate to the valve 28 being operated on a timer basis, it can include sensors to allow it to operate on the basis of some physical characteristic of the gas within the pressure vessel 12. For example, the valve 28 can operate on the basis of the gas pressure within the pressure vessel 12 or the tube 16 dropping to a predetermined level, or the gas temperature within the pressure vessel 12 or the tube 16 reaching a predetermined level, or on the basis of a predetermined pressure or temperature difference existing between the gas within the pressure vessel 12 and at a specific location within the tube 16; or the difference in pressure of gas at the first and second openings 18,20 of the tube 16. Further, as explained below, when the vessel 12 is incorporated into an insect control apparatus, the valve 28 can also be operated or controlled on the basis of other characteristics such as ambient light, temperature, pressure or wind speed.

Embodiments of the apparatus 10 can be used to provide, from a short pulse of gas, a continuous slow release of gas. Because the gas is pulsed into the pressure vessel 12, the valve 28 is only operated for a short period of time thereby minimizing power requirements. Further, as the slow release is effected by simply mechanical means, namely the restrictor tube 16, complex pressure regulators or valving and plumbing is not required.

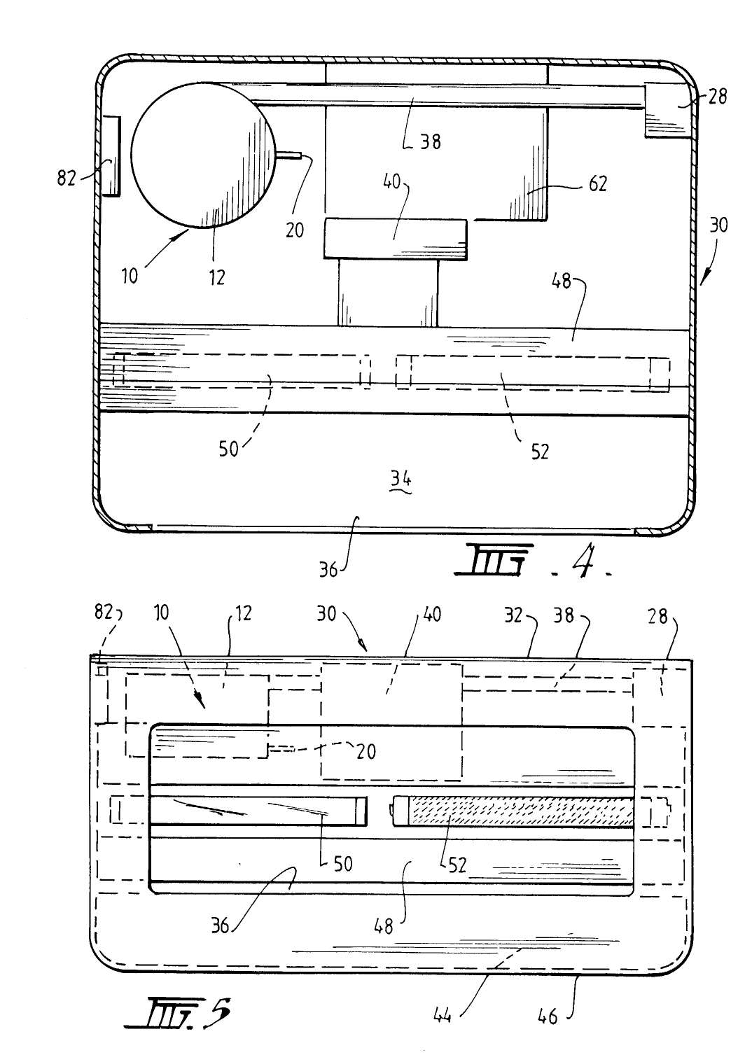

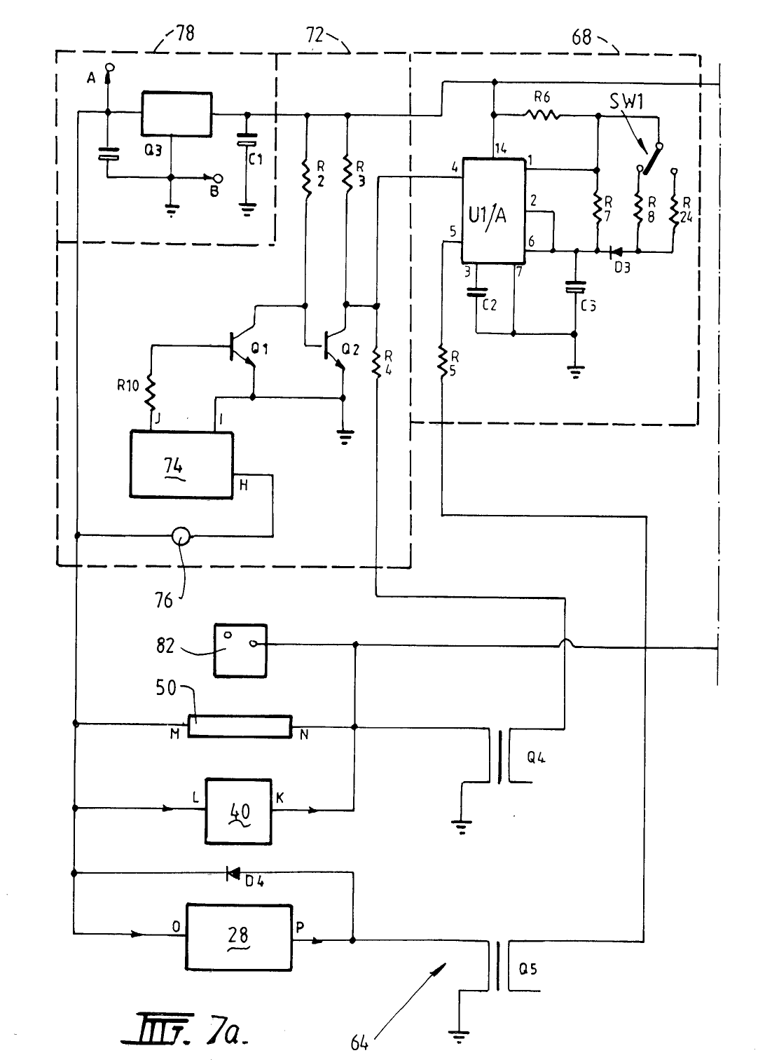

An application of the apparatus 10 is depicted in FIGS. 3-5 which illustrates an insect control apparatus. The insect control apparatus (also referred to herein as “trap”) 30 includes a generally rectangular housing 32 defining an insect collection chamber 34. The housing 32 is provided with aperture or opening 36 to allow an insect to enter the chamber 34 and also to allow attractants to pass from the housing 32 to the surrounding atmosphere. In this embodiment, the apparatus 10 differs from that depicted in FIGS. 1 and 2 by forming the pressure vessel with an integral extension passage 38 that communicates with the valve 28. The apparatus 10 is supported within an upper region of the housing 32 with the second opening 20 disposed to provide a slow continuous release of gas within the chamber 34. An electric fan 40 is held within the upper region of the housing 32 adjacent the apparatus 10 for producing an air flow 42 that circulates within the housing 32 in a direction so as to produce a down draught in the chamber 34 adjacent the opening 36.

A removable solution tray 44 is supported on a lower wall 46 of the housing 32 and is positioned so that at least a forward end of the tray 44 is beneath the down draught produced by the air flow 42. The tray 44 is used to hold a body of liquid that assists in the entrapment or killing of insects entering the trap 30. In its most basic form, the liquid can be water so that insects entering the housing 32 that are asphyxiated by the gas released by the apparatus 10 fall into the water in the tray 44 and drown. Alternately insects may directly enter the tray 44 and become entrapped and drown. The entrapment of insects in tray 44 is enhanced by the down draught created by the air flow 42 which tends to blow insects into the liquid held within the tray 44.

It is envisaged that the liquid in tray 44 will include chemicals that act as an attractant to the insects desired to be caught by the trap 30. Two particular chemicals envisaged for use in attracting mosquitoes are lactic acid and octenol. Lactic acid is present in human sweat and is believed to be an attractant to mosquitoes. Octenol is another chemical that is believed to act as attractant for both mosquitoes and flies and in particular the tsetse fly.

The scent or odour of lactic acid, octenol and the gas (typically carbon dioxide) released by the apparatus 10 is able to waft through the opening 36 into the atmosphere surrounding the trap 30. Of course the concentration of the scent is greatest within the housing 32. Thus, insects picking up the scent from outside the trap 30 may be lured into the housing 32.

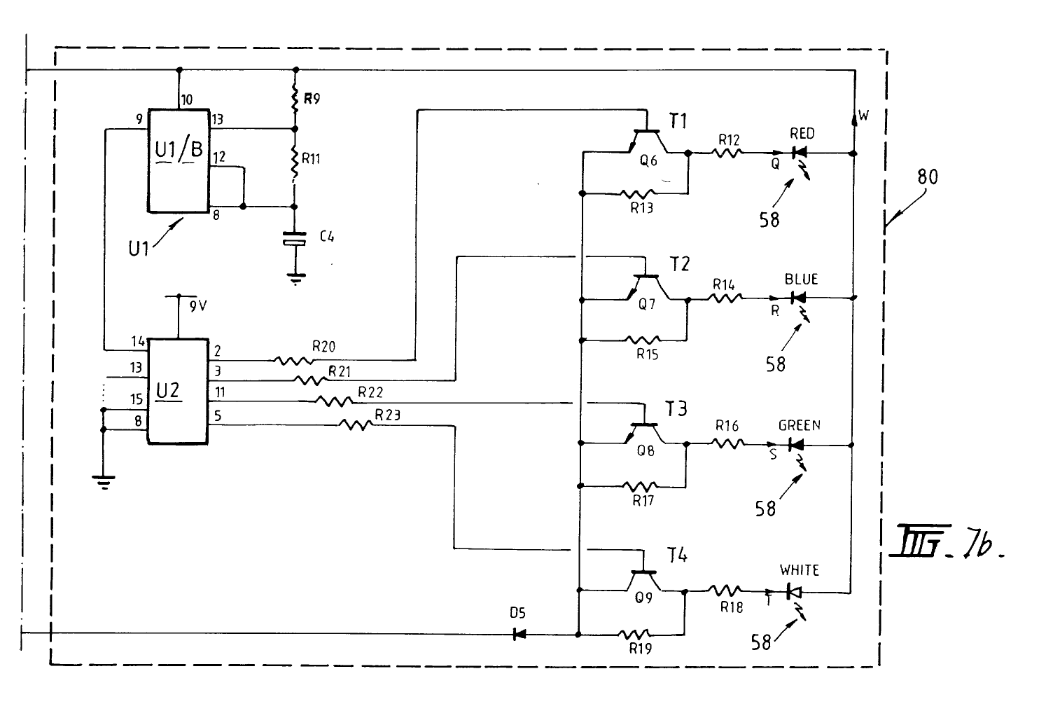

The trap 30 also includes a light source 48 for emitting light of wavelengths attractive to a particular insect or range of insects desired to be trapped. The light source 48 comprises a combination of an ultraviolet light 50 and a broad spectrum light 52. The ultraviolet light 50 can be in the form of a standard ultraviolet tube. The spectrum light 52 is a specially designed light for emitting a wide range of different wavelengths. One form of spectral light 52 is depicted in FIG. 6a and 6b. The spectrum light 52 comprises a light mixer in the form of a transparent or translucent prism 54 to which devices that emit light of different wavelength are optically coupled. This coupling is achieved by providing recesses 56 provided at opposite ends of the prism 54 into which the devices are fitted. These devices most typically would be in the form of LED's 58. In this embodiment, four LED's are mounted on each end of the prism 54 and ideally would comprise LED's of the three primary additive colours (red, green and blue) together with one LED for providing white light. Typically, the primary additive spectral colours of the LED's 58 would be red—640 nm; green—537 nm; and blue—464 nm. The light source 48 can be controlled to produce light of wavelengths in a range from around 350 nm (near ultraviolet) to around 660 nm. The outside surface of the prism 54 is provided with an array of grooves or scratches 60 to increase the refraction of light emitted by the spectral light 52. The graver/scratches 60 extend at about 60° to the length of the prism 54. In addition, or as an alternative to the provision of the grooves/scratches 60, the outside surface of a prism 54 can be frosted.

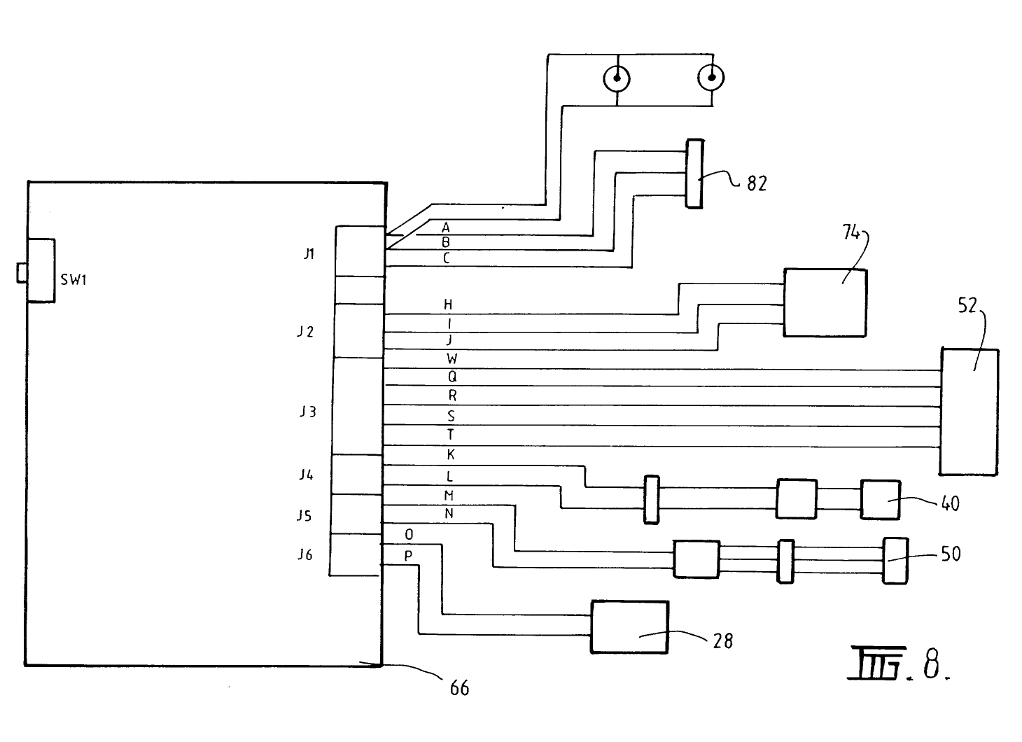

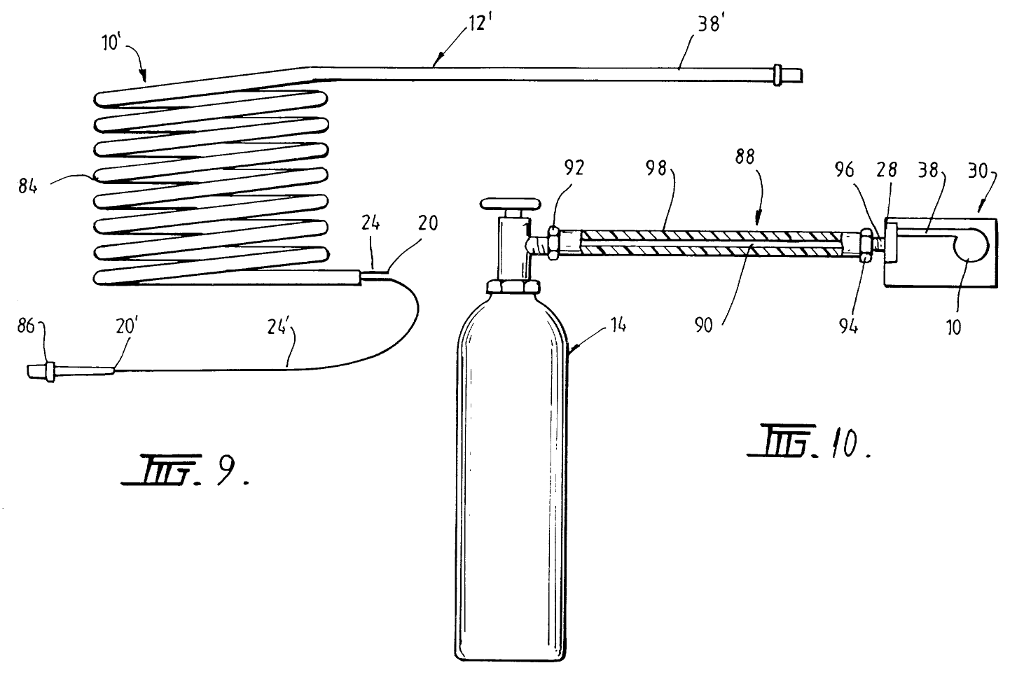

The circuitry for operating and controlling the apparatus 10 and light source 48 is held within an enclosure 62 retained within the housing 32. FIGS. 7 and 8 illustrate one embodiment of a circuit held within the enclosure 62. The circuit 64 depicted in FIG. 7 is mounted on a printed circuit board (PCB) 66 depicted in FIG. 8. FIG. 8 illustrates the connection of various components of the trap 30 to the circuit 64. The circuit 64 has several main blocks or sections. The valve timing and auxiliary control section 68 sets one or two predetermined duty cycles for pulsing the valve 28 to release gas held within a storage vessel into the apparatus 10. The duty cycle required can be selected by manipulation of switch SW1 which is accessible on a back panel 70 of the housing 32. The circuit section 68 also controls the fan 40 and UV light 50.

Another important section of the circuit 64 is the master control module 72 which includes a clock 74 for setting the ON/OFF operating time for the trap 30. The clock 74 also has controls accessible from the back panel 70 for setting the operational time of the trap 30. This can include operating the trap 30 continuously twenty-four hours a day. One or more sensors 76 can be placed in a control line H from the clock 74 to a power supply circuit 78 for providing a trigger to the operation of the valve timing and auxiliary control circuit 68. The sensors 76 can for example sense physical parameters such as temperature, light levels, air pressure or wind speed in the vicinity of the trap 30 for enabling the timing circuit 68. Thus while the master control circuit 72 and in particular the clock 74 can set the time period at which power is made available to the valve timing and auxiliary control circuit 68, the sensors 76 can, in that time period, control the provision of power to the circuit portion 68.

The circuit 64 further includes a spectrum light control block 80 for controlling the LED's 58. The circuit block 80 receives a regulated voltage via the power supply circuit 78. Circuit 80 includes an astable oscillator U1 formed by a common 555 timer chip and provides clock pulses to pin 14 of chip U2 which is a 4022 counter. Chip U2 can be configured to provide four or eight outputs. In the present circuit, one of the LED's 58 is coupled to each second output and the chip U2 is configured to give a pause between colour changes, i.e., illumination of different LED's. Each time the counter U2 receives a clock pulse from oscillator U1, it switches on the next output in order, thus sequencing through all of its outputs cyclically. The frequency of the clock pulses is determined by U1 and can be set to any desired frequency but typically for any particular application is fixed to one frequency. As each second output of the counter U2 switches on, it in turn switches on transistors T coupled to that output to fully illuminate an associated LED 58. The LED's do not, in this application, fully turn off, rather they are always partially illuminated. If desired, a capacitor can be coupled to the base of each transistor T to soften the visual transition from one colour to another as sequential LED's are switched between a partially illuminated state and the fully illuminated state. However the LED's may also be switched randomly and be subjected to intensity modulation.

A slave socket 82 is provided in the circuit 64 to enable to control a fan and light source of a slave trap (not shown). The slave trap would be located remotely from the trap 30 and would include only a fan, light source and solution tray. That is, the slave trap is in essence identical to trap 30 but with the omission of the apparatus 10 and circuit 64. All control over the slave unit would be via the electronic circuit 64 held within the housing 32 of the trap 30. A slow gas release is provided to the slave unit by modifying the apparatus 10 to include a second restrictor tube that couples into the slave unit. An example of a modified slow gas release apparatus 10′ (referred to as the “twin slow release chamber 10′) is depicted in FIG. 9. Here, the pressure vessel 12′ is in the form of a copper pipe formed with a straight length 38′ (that would be connected to valve 28) and a coiled section 84. Inside the coil 84 are two separate lengths of restrictor tube similar to restrictor tube 16 depicted in FIG. 1. One of the restrictor tubes has a length 24 extending from the copper tubing 12′ and terminating in the opening 20 that is disposed within the housing 32 of trap 30. The second restrictor tube has a length 24′ that extends to a slave trap (not shown) to provide a slow release of gas to the slave trap. Opening 20′ of the length 24′ is attached to a coupling 86 to allow connection with the housing of the slave unit. When the twin slow release chamber 10′ is used, the duty cycle of the valve 28 is arranged first to stay on for a greater period of time (for example instead of staying open for one tenth of a second every thirty seconds perhaps it may stay open around 0.18 seconds every thirty seconds so that approximately 220 grams of gas per hour is continuously released by the twin chamber 10′). The switch SW1 shown in FIG. 8 can be moved between different positions to regulate the gas bleed depending on whether or not a slave trap and an associated twin slow release chamber 10′ is used.

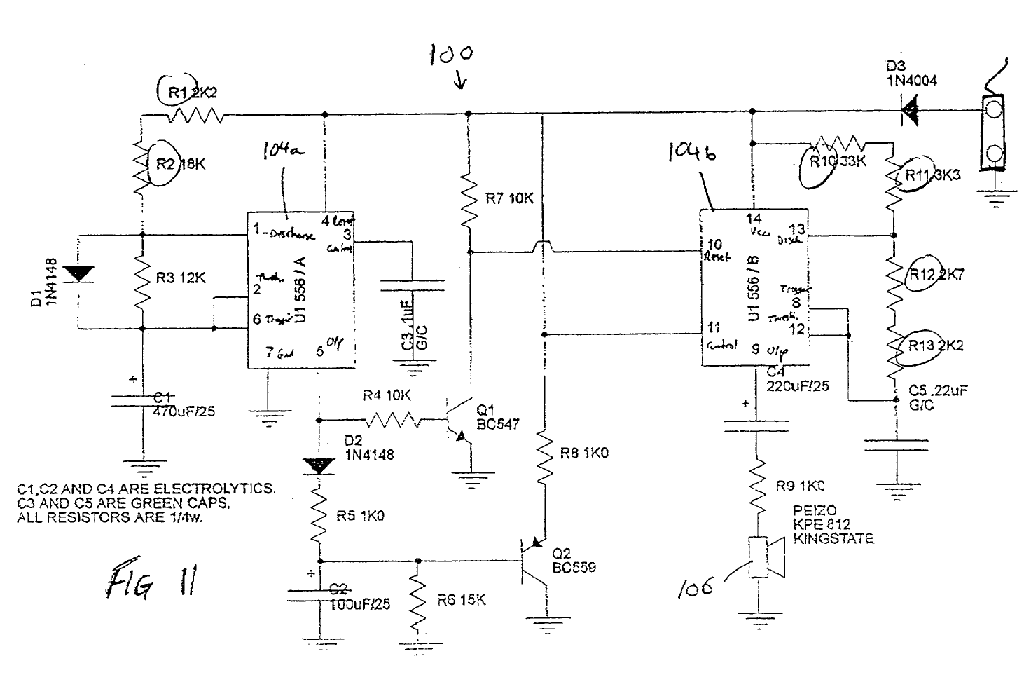

To provide gas to the trap 30 and in particular the apparatus 10, typically a bottle 14 of compressed gas would be connected to the valve 28. One way of doing this would be to use a conventional high pressure hose. However, such hoses are relatively expensive. FIG. 10 illustrates, a new hose 88 for this purpose comprising a metallic (typically copper) restrictor tube 90 having connector nut 92 at one end for connecting to the bottle 14 compressed gas and a nut 94 at the other end for connecting to a coupling 96 extending from the valve 28. The tube 90 is covered by a rubber hose 98 or similar casing to protect it and prevent it from being bent at a sharp angle. By use of this hose 88, there would be no need to incorporate a pressure regulator between the gas bottle 14 and the valve 28.

As an addition or alternative to the apparatus 10 the trap 30 can include a sonic signal generating system 100 depicted in FIG. 11 for luring insects into the chamber 34. That is, the insect control apparatus 30 can be constructed to include one or both of the apparatus 10 or the sonic signal generating system 100 for luring an insect into the chamber 34 and further, if both the apparatus 10 and the system 100 are provided the trap 30 can be further modified to selectively disable the apparatus 10. This disabling can be effected most simply by not connecting the gas inlet 26 to the cylinder 14.

The system 100 depicted in FIG. 11 is an electronic circuit which generates a sonic signal which sweeps through frequencies in the range of about 80 Hz to 680 Hz. It has been discovered that sonic signals within this frequency range act as an audio attractant to various insects and in particular to mosquitoes. Moreover, sonic signals within this frequency range are believed to mimic the sonic signals produced by a female mosquito during a feeding frenzy.

The system 100 includes a connector 102 that can couple to the slave socket 82 of the circuit 64 depicted in FIG. 8. The circuit 100 utilises a 556 dual timer chip which is notionally represented as two separate timing chips 104a and 104b. The 556 dual timer is a single 14 pin package containing two 555 timers. Pin 9 of timer 104b provides a signal to drive a piezo electric speaker 106 generating the sonic signals for luring insects into the trap 30. The frequency range of the signal emitted by the piezo electric speaker 106 is determined by the resistors R10, R11, R12, R13 and capacitor C5. However, the output of timer 104b is in turn controlled by the timer 104a. In particular, the reset pin 10 of timer 104b is coupled to transistor switch Q1 which in turn is driven by the output at pin 5 of the timer 104a. The signal at pin 5 of timer 104a is determined by the resistors R1, R2, R3 and capacitor C1. Thus, in effect, timer 104a controls the duty cycle of 104b. This duty cycle can thus be varied by varying any one or more of the components R1, R2, R3 and C1. These components are typically set to provide a duty cycle (i.e., period.) of about 15 seconds with an ON time of about ten (10) seconds and an OFF time of about five (5) seconds. Of course, by appropriate re-wiring, the circuit 100 can produce a continuous rather than pulsed sonic signal. For example this can be achieved by tying reset pin 10 of timer 104b directly to the voltage supply. Thus typically the generator will produce a sonic signal having a frequency which starts at about 80 Hz and ramps up to about 680 Hz (i.e., the sonic signal has a frequency sweeping from about 80 Hz to 680 Hz) in a period of about ten (10) seconds (ON period) then is turned OFF for about five (5) seconds (OFF period) before restarting and cycling in a like manner ad infinitum.

The operation various embodiments of the trap 30 will now be described.

In one embodiment, a solution typically incorporating lactic acid and octenol is placed in the solution tray 44 and then slid into the housing 32. Next, the clock 74 is adjusted via the back panel 70 to set the time of operation of the trap 30. For example, the clock 74 may be set to operate the trap 30 between 6:00 p.m. and 6:00 a.m. everyday. (Although as explained above, the clock can be set to run the trap 30 twenty-four hours a day.) When the apparatus 10 is incorporated into the insect control apparatus 10, the switch SW1 is moved between two positions to set the duty time for the operation of valve 28 to allow recharging of the pressure vessel 12 as compressed gas from a gas supply connected with the valve 28. Typically, on initial activation of the trap 30, the valve 28 will be operated for a predetermined time set by the switch SW1 to charge the pressure vessel 12 with a volume of compressed gas from the bottle 14 connected by hose 88. The fan 40 will also be operated as well the light source 48 during the ON time provided by the clock 74 and master control circuit 72. Compressed gas is slowly released into the chamber 34 via open end 20 of the restrictor tube 16 held within the pressure vessel 12. The released gas is circulated through the housing 32 by action of the fan 40. The circulating gas together with the scent from the solution held within the tray 44 is able to waft to the surrounding atmosphere through the opening 36. The scent of the liquid held within the tray 44 together with the scent of the gas, attracts insects to the trap 30. Additionally, the light source 48 operates to radiate light at a plurality of different wavelengths and intensities to further act as a visual stimulus and attractant to the insects. The sonic signal generating system 100 generates an audio signal of a frequency sweeping through the range of about 80 Hz to 680 Hz which acts as an audio attractant to flying insects and in particular, mosquitoes. The duty cycle of the sonic signal can be varied but it is preferred to have an ON period of up to 10 seconds with a maximum OFF period of up to 5 seconds by appropriate adjustment of resistors R1, R2, R3 and/or capacitor C1. Insects entering the chamber 34 may by virtue of attraction of the solution in the tray 44 fly or crawl into the solution and thus become trapped. Alternately, the down draught provided by the circulating air 42 can drive the insects into the solution in tray 44 again acting to entrap the insects. The gas released into the chamber 34 acts to asphyxiate the insects.

One or more slave units or traps can be coupled to the trap 30 via the slave socket 82 to provide a wider area of operation. With the system 100 in use, this will require a slight modification of the circuit depicted in FIG. 8 to provide a plurality of parallel connectors 82.

The apparatus 30 is particularly directed to attract female mosquitoes. In particular the sweeping frequency pulsed sonic signal is intended to communicate to female mosquitoes that a blood meal is available and to fertilise their eggs. It is not intended to specifically attract male mosquitoes. The communication is further enhanced by the other features described viz the lighting, gas and attractant liquids.

Now that embodiments of the present invention have been described in detail, it will be apparent to those skilled in the relevant arts that numerous modifications and variations may be made without departing from the basic inventive concepts. For example, the pressure vessel 12 can be made of any particular shape and configuration. Similarly, the restrictor tube 16 can be wound to any desired configuration within the pressure vessel 12. Also, the diameter of the restrictor tube 16 can be different for the coiled length 22 and the straight length 24.

In relation to the insect control apparatus 30, the provision of liquid within the tray 44 is not essential. Initial experiments have found that embodiments of the trap 30 without the inclusion of a liquid in the tray 44 are nonetheless effective for attracting and asphyxiating insects. The liquid in tray 44 assists in positively entrapping and killing insects and also, as described above, allows for the inclusion of chemicals that can act to further attract the insects. It is also possible for the length 24 of restrictor tube 16 outside of the pressure vessel 12 to be directed so as to release gas into the liquid held within tray 44. This may have the added benefits of assisting in releasing attractive scents from the liquid to the atmosphere and also in reducing the surface tension of the liquid within the tray 44.

All such modifications and variations together with others that would be obvious to a person of ordinary skill in the art are deemed to be within the scope of the present invention, the nature of which is to be determined from the above description and the appended claims.

What is claimed is:

1. An insect control apparatus comprising at least:
a housing bounding an insect collection chamber, the housing having one or more apertures to allow an insect to enter the chamber;
a sonic signal generating system for generating and broadcasting a sonic signal which sweeps through a range of frequencies to lure an insect into said insect collection chamber said sonic generating system comprising means for pulsing said sonic signal so that said sonic signal is cyclically turned ON and OFF; and
means disposed in said insect collection chamber for killing or trapping an insect residing in said insect collection chamber.

2. The apparatus according to claim 1 wherein said range of frequencies is between about 80 Hz to 680 Hz.

3. The apparatus according to claim 2 wherein said sonic signal is turned ON for up to about 10 seconds.

4. The apparatus according to claim 3 wherein said sonic signal is turned OFF for up to about 5 seconds.

5. The apparatus according to claim 3 wherein said sonic signal is turned ON for about 10 seconds and turned OFF for about 5 seconds.

6. The insect control apparatus according to claim 1, further comprising an apparatus for providing a continuous slow release of a compressed gas within said insect collection chamber.

7. The insect control apparatus according to claim 6, wherein said apparatus for providing a continuous slow release of compressed gas comprises at least:
a pressure vessel having a gas inlet adapted for connection to a supply of compressed gas;
a restrictor tube having a first length provided with a first open end each located within said pressure vessel and a second length provided with a second open end each located outside the pressure vessel, the restrictor tube being configured such that when the supply of compressed gas is connected to the pressure vessel by the gas inlet so that a volume of gas is transferred from the supply of compressed gas to the pressure vessel, the volume of gas enters the first open end of the restrictor tube, travels through the first and second lengths of the restrictor tube and exits from the second open end of the restrictor tube to provide a continuous slow release of the volume of gas from the pressure vessel.

8. The insect control apparatus according to claim 7, wherein said apparatus for providing a continuous slow release of compressed gas further comprises means for opening, from time to time, a fluid communication path between said supply of compressed gas and said pressure vessel to charge said pressure vessel with said volume of compressed gas.

9. The insect control apparatus according to claim 8, wherein said restrictor tube has an internal diameter in the order of 0.5 to 2 mm.

10. The insect control apparatus according to claim 1, further comprising a light source for continuously producing a light of a wavelength attractive to a range of insects desired to be trapped.

11. The insect control apparatus according to claim 10, wherein said light source includes at least two light emitting devices emitting light of different wavelengths.

12. The insect control apparatus according to claim 11, wherein said light source comprises a light mixer for mixing the light emitted by said light emitting devices.

13. The insect control apparatus according to claim 12, wherein said light mixer comprises a transparent or translucent prism to which said light emitting devices are optically coupled.

14. The insect control apparatus according to claim 13, wherein said prism is provided with an outer surface having an array of surface grooves or scratches for refracting light emitted by said light emitting devices as it passes from the prism to the surrounding atmosphere.

15. The insect control apparatus according to claim 14, wherein the outer surface of the prism is frosted.

16. The insect control apparatus according to claim 11 further comprising a light source circuit for pulsing said light emitting devices.

17. The insect control apparatus according to claim 1 further comprising a body of liquid held in said insect collection chamber into which insects within said insect collection chamber can fall and become trapped.

18. The insect control apparatus according to claim 1 further comprising means for circulating air through said housing in a direction to produce a downdraft near said opening toward said body of liquid.

19. An insect control apparatus comprising at least:
a housing bounding an insect collection chamber, the housing having one or more apertures to allow an insect to enter the chamber;
a sonic signal generating system for generating and broadcasting a sonic signal which sweeps through a range of frequencies of about 80 Hz to 680 Hz to lure an insect into said insect collection chamber;
means disposed in said insect collection chamber for killing or trapping an insect residing in said insect collection chamber;
a pressure vessel having a gas inlet adapted for connection to a supply of compressed gas;
a restrictor tube having a first length provided with a first open end each located within said pressure vessel and a second length provided with a second open end each located outside the pressure vessel, the restrictor tube being configured such that when the supply of compressed gas is connected to the pressure vessel by the gas inlet so that a volume of gas is transferred from the supply of compressed gas to the pressure vessel, the volume of as enters the first open end of the restrictor tube, travels through the first and second lengths of the restrictor tube and exits from the second open end of the restrictor tube to provide a continuous slow release of the volume of gas from the pressure vessel into said insect collection chamber; and
means for opening, from time to time, a fluid communication path between said supply of compressed gas and said pressure vessel to charge said pressure vessel with said volume of compressed gas.

20. The insect control apparatus according to claim 19, wherein the sonic signal generating means further comprises means for cyclically pulsing said sonic signal ON and OFF.

21. The apparatus according to claim 20 wherein said sonic signal is turned ON for up to about 10 seconds.

22. The apparatus according to claim 21 wherein said sonic signal is turned OFF for up to about 5 seconds.

23. The insect control apparatus according to claim 19, wherein said restrictor tube has an internal diameter in the order of 0.5 to 2 mm.

24. The insect control apparatus according to claim 19, further comprising a light source for continuously producing a light of a wavelength attractive to a range of insects desired to be trapped.

25. The insect control apparatus according to claim 24, wherein said light source comprises at least two light emitting devices emitting light of different wavelengths.

26. The insect control apparatus according to claim 25, wherein said light source comprises a light mixer for mixing the light emitted by said light emitting devices.

27. The insect control apparatus according to claim 26 wherein said light mixer comprises a transparent or translucent prism to which said light emitting devices are optically coupled.

28. The insect control apparatus according to claim 27, wherein said prism is provided with an outer surface having an array of surface grooves or scratches for refracting light emitted by said light emitting devices as it passes from the prism to the surrounding atmosphere.

29. The insect control apparatus according to claim 27, wherein the outer surface of the prism is frosted.

30. The insect control apparatus according to claim 20 further comprising a body of liquid held in said insect collection chamber into which insects within said insect collection chamber can fall and become trapped.

31. The insect control apparatus according to claim 29 further comprising means for circulating air through said housing in a direction to product a downdraft near said opening toward said body of liquid.
